(19) United States
(12) Patent Application Publication
(10) Pub. No.: US 2003/0079015 A1
(43) Pub. Date: Apr. 24, 2003

(54) Method, apparatus and program product providing business processes using media identification and tracking of associated user preferences

(75) Inventors: Gene S. Fein, Lenox, MA (US); E. Oliver Jones, Andover, MA (US); Anthony Salotto, Norton, MA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: DotClick Corporation, Boston, MA (US)

(21) Appl. No.: 10/143,729

(22) Filed: May 8, 2002

Related U.S. Application Data
(60) Provisional application No. 60/289,768, filed on May 9, 2001.
(60) Provisional application No. 60/289,772, filed on May 9, 2001.

(51) Int. Cl. G06F 15/173

(52) U.S. Cl. 709/225

(57) ABSTRACT

A method for targeted market testing and promotion of a media recording for an media recording distribution entity is provided using a computer program plug-in and collecting information related to a playing media recording. Based upon the collected information, playing media recording preferences are stored and cross-referencing the in a user preference database. Computer users having a preference associated with the media recording are identified by analyzing the user preference database. Selected media recording are distributed to the identified users for playing. User reactions to the selected media recording are gathered, both actively and passively. The gathered user reaction information is analyzed and reported on.

### RELATED APPLICATION(S)

This application claims the benefit of U.S. Provisional Application No. 60/289,768 filed on May 9, 2001 and U.S. Provisional Application No. 60/289,772 filed on May 9, 2001. The entire teachings of the above application(s) are incorporated herein by reference.

### BACKGROUND OF THE INVENTION

This invention relates generally to tracking user preferences, and more specifically to providing business processes employing media identification and tracking of associated user preferences.

### SUMMARY OF THE INVENTION

A method for targeted market testing and promotion of a media recording for a media recording distribution entity is provided using a computer program plug-in and collecting information related to a playing media recording. Based upon the collected information, playing media recording preferences are stored and cross-referenced in a user preference database. Computer users having a preference associated with the media recording are identified by analyzing the user preference database. Selected media recording are distributed to the identified users for playing. User reactions to the selected media recording are gathered, both actively and passively. The gathered user reaction information is analyzed and reported on. Analyzing and reporting can allow users to recruit other users to be targeted for distributions. The media recording distribution entity can be a radio station.

A method for providing retail marketing and promotion of a media recording is provided for a media recording distribution entity using a computer program plug-in and collecting information related to a playing media recording. Based upon the collected information, playing media recording preferences are stored and cross-referenced in a user preference database. Computer users having a preference associated with the media recording are identified by analyzing a user preference database. The identified users are sent a message regarding information for purchasing the media recording. User reactions to the message are gathered, both actively and passively. The gathered user reaction information is analyzed and reported on. Analyzing and recording can allow users to recruit other users to be targeted for distributions. The media recording distribution entity can be a media recording retailer.

A method for marketing and promotion for a concert is provided by identifying computer users having a preference associated with the concert by analyzing a user preference database. Identified users are identified according to a relationship between the geographic location of the concert and a designated marketing area associated with the user. A message regarding the concert is distributed to the selected users. The message can enable the user to purchase tickets for the concert. The message can be distributed in real-time as the user is listening to a media recording associated with the concert. The selected users can recruit other users to be targeted for distributions.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 illustrates a digital music network on which an embodiment of the present invention is implemented.

FIG. 2 is a diagram of the internal structure of a node on the digital music network of FIG. 1 configured according to an embodiment of the present invention.

FIG. 3 illustrates an overview of a business process using media identification and tracking of associated user preferences.

FIG. 4 illustrates a embodiment of the present invention used for a radio research and testing program.

FIG. 5 illustrates a “Concert” alert.

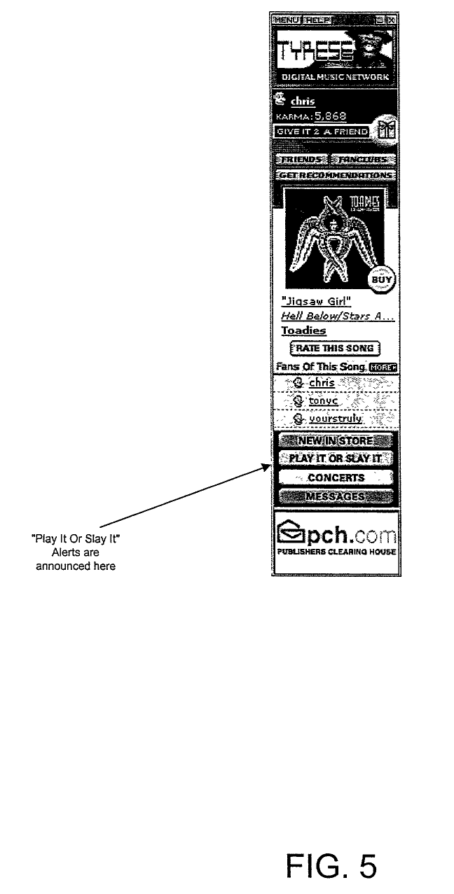

FIG. 6 illustrates a “New in Store” alert.

FIG. 7 illustrates a embodiment of the present invention used for a retail marketing and promotion program.

FIG. 8 illustrates a “Concert” alert.

### DETAILED DESCRIPTION OF THE INVENTION

A description of preferred embodiments of the invention follows.

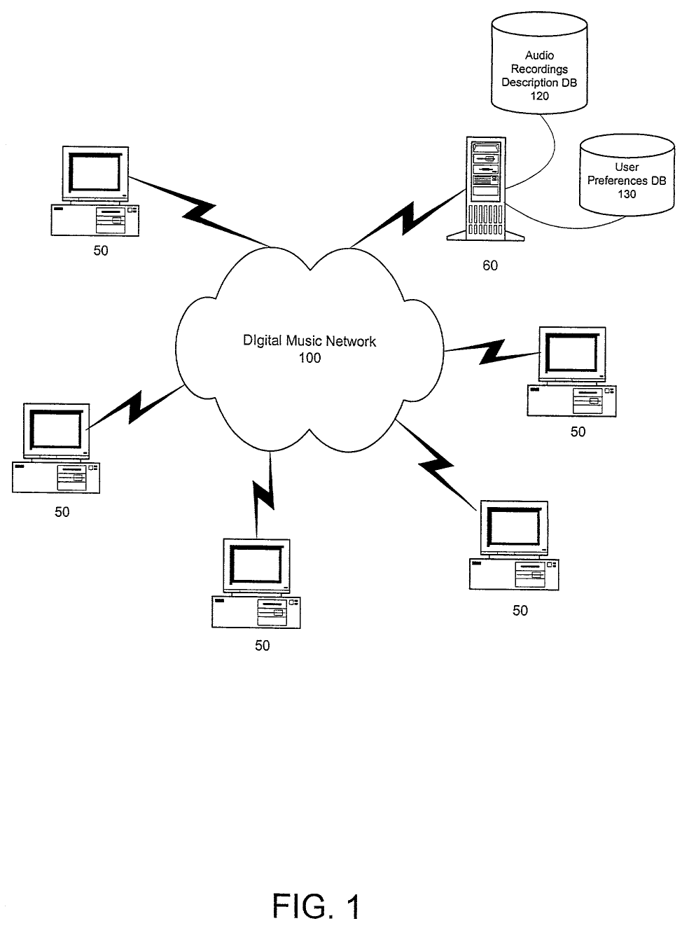

FIG. 1 is a diagram of a computer system on which an embodiment of the present invention is implemented. Client computer 50 provides processing, storage, and input/output devices playing recorded media. The client computers 50 can also be linked through a digital music network 100 to other computing devices, including other client computers 50 and server computers 60. The digital music network 100 can be part of the Internet, a worldwide collection of computers, networks and gateways that currently use the TCP/IP suite of protocols to communicate with one another. The Internet provides a backbone of high-speed data communication lines between major nodes or host computers, consisting of thousands of commercial, government, educational, and other computer networks, that route data and messages. In one embodiment of the present invention, user preference information is collected and recorded in a user preferences database 130. Additionally, audio listening history is collected and recorded in an audio recordings description database 120. Business processes then utilize media identification and tracking of associated user preferences to provide services to end-users.

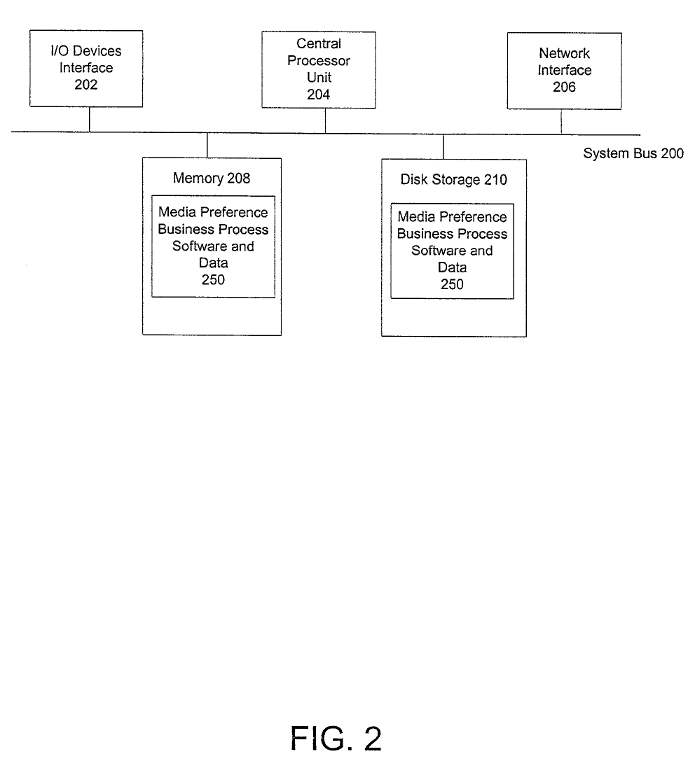

FIG. 2 is a diagram of the internal structure of a computer (e.g., 50, 60) in the computer system of FIG. 1. Each computer contains a system bus 200, where a bus is a set of hardware lines used for data transfer among the components of a computer. A bus 200 is essentially a shared conduit that connects different elements of a computer system (e.g., processor, disk storage, memory, input/output ports, network ports, etc.) that enables the transfer of information between the elements. Attached to system bus 200 is an I/O device interface 202 for connecting various input and output devices (e.g., displays, printers, speakers, etc.) to the computer. A network interface 206 allows the computer to connect to various other devices attached to a network (e.g., network 70). A memory 208 provides volatile storage for computer software instructions (e.g., media preference business process software and data 250) and data structures (e.g., user preferences database 130 and audio recordings description database 120) used to implement an embodiment of the present invention. Disk storage 210 provides non-volatile storage for computer software instructions (e.g., media preference business process software and data 250) and data structures (e.g., user preferences database 130 and audio recordings description database 120) used to implement an embodiment of the present invention. A central processor unit 204 is also attached to the system bus 200 and provides for the execution of computer instructions (e.g., media preference business process software and data 250), thus allowing for the implementation of business process using media identification and tracking of associated user preferences on a digital music network.

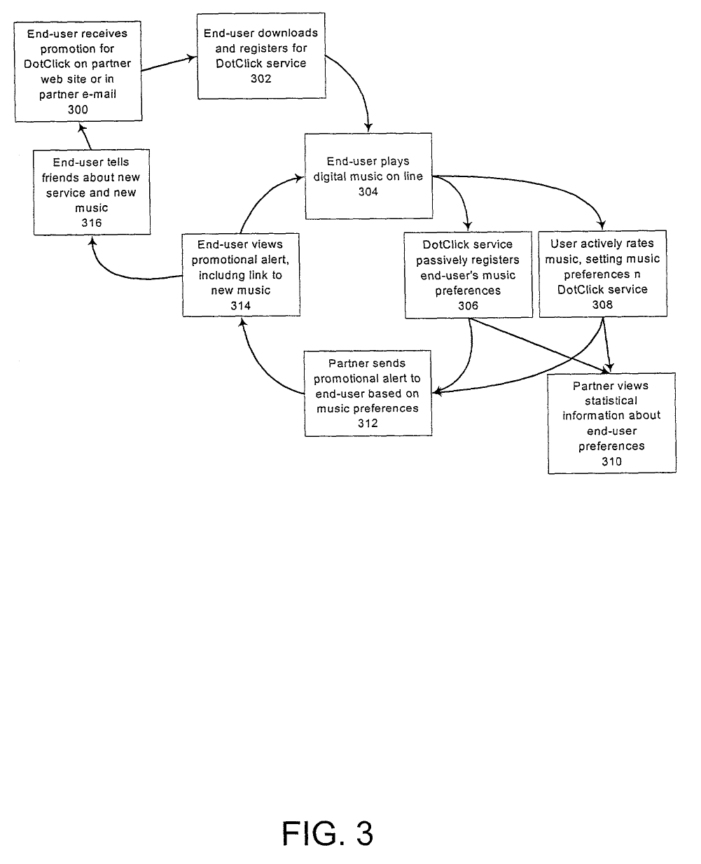

FIG. 3 illustrates an overview of a business process using media identification and tracking of associated user preferences. In one embodiment the present invention is used in conjunction with a service for augmenting end-user's listening experience. An end-user receives a promotion for the service on a partner Web site, in a partner e-Mail, or knowledge of the service by any other means at Step 300. The end-user downloads and registers for the service at Step 302. At Step 304 the end-user plays music while being connected online. User preferences can be gathered both passively and actively. The service passively registers the end-user's music preferences at Step 306. At Step 308 the end-user actively rates music, setting music preferences within the service. Partners view statistical information about end-user preferences at Step 310. Partners send promotional alerts to end-users based on their music preferences at Step 312. At Step 314 end-users view promotional alerts, including links to new music. End-user tells friends about the service and new music at Step 316, causing further promotion of the service (e.g., through Step 300).

For the music industry, the present invention helps fulfill the Internet's potential as a tool for reaching fans. The present invention provides direct links between artists and fans, and therefore removes barriers to direct marketing by delivering effective, timely, and desired messages. These same messages induce the recipient to provide feedback—in the form of ratings—to the system and business process, as well as to the music promoter. The overall feedback loop induces users to listen to music and disclose their preferences. It rewards them with targeted access to new music and the chance to express their preferences, inducing them to reveal more of their preferences, and to tell their friends about the service. This in turn increases the precision of the targeting, and produces more accurate statistical information for business partners.

Each major record label currently spends as much as $100 million yearly on radio promotion and marketing. There are over 300 new songs being promoted to radio stations each week, but only 10% of these will ever see significant airtime. Thus a considerable amount of a record label's promotional budget is wasted on songs that will not be heard by listeners. Meanwhile, radio stations currently do some testing in order to figure which songs will perform best, but most of this testing is conducted via telephone outcall—by placing survey calls to fans.

The service, as implemented in an embodiment of the present invention tests individual songs over the Internet before their release, via alliances with radio station Web sites. This dramatically improves a record labels' efficiency in determining song-release strategies, and will improve the information radio station programmers use to determine what their listeners most want to hear.

Individual radio station Web sites (collectively, the “Radio Station Group”) will distribute the service to their member bases, establishing an expanding network of users, many of whom are ready to listen to pre-release songs and provide feedback. The benefits of testing with service are clear: the technology, which uses both passively gathered and actively provided user preferences from a large population of users allows highly precise control over targeting. Because the service can control the testing audience via our powerful targeting technology, a record label can be sure the testers are fans of a certain artist or a certain music genre. The present invention's reporting mechanism is built-in and on-demand, so record labels receive timely, sortable reports that indicate how well a song performs before labels have to sink significant promotional dollars into that song.

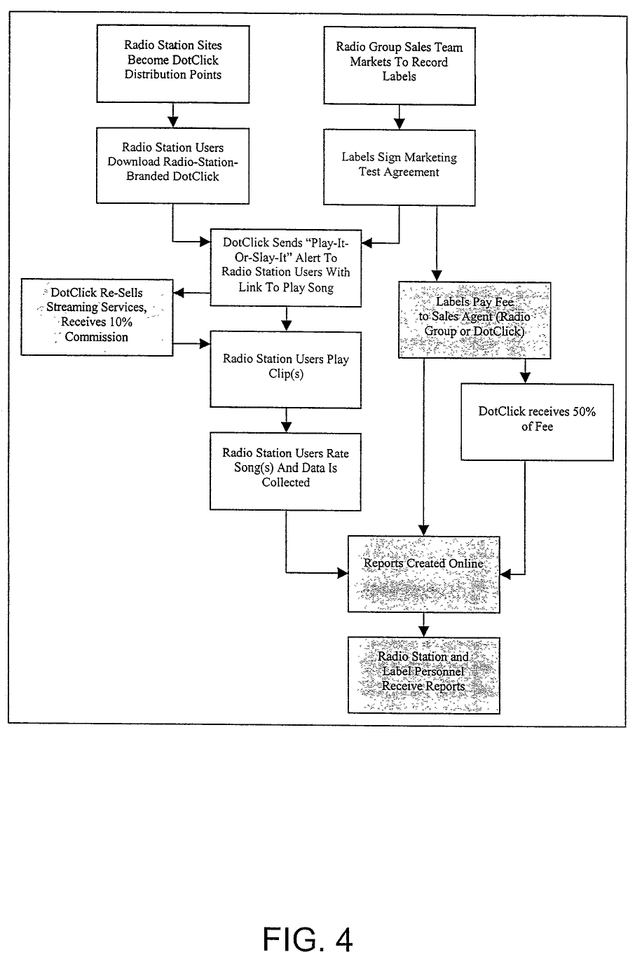

FIG. 4 illustrates a embodiment of the present invention used for a radio research and testing program. The a radio research and testing program is sold to a record label by the radio station group (or by a designated consultant). In concert with the Radio Station Group, an arrangement for the hosting of songs or song clips to be tested is made. Over the course of a predefined period, alert are sent to the appropriate Digital Music Network members (i.e., those members that are fans of artists or music genres requested by the record label); this alert contains a hyperlink to one or more of the songs or song clips. After listening to the songs, members are asked to “Play It or Slay It,” (see FIG. 4) thereby contributing to the ratings data collected. Data is compiled into a report with full demographic breakdown; this report is available online, on-demand.

The business of promoting new releases is extremely expensive. The cost to a record label of retail promotion programs can range from $25,000 for an end cap display at a national retailer to over $50,000 for an artist wall. Smaller programs include hundreds of dollars for a shelf marker and a few thousand dollars for listening stations. Considering the fact that there are at least 1,100 new records debuting at retail in any given month, record labels must spend a huge amount of money to get any attention for their releases.

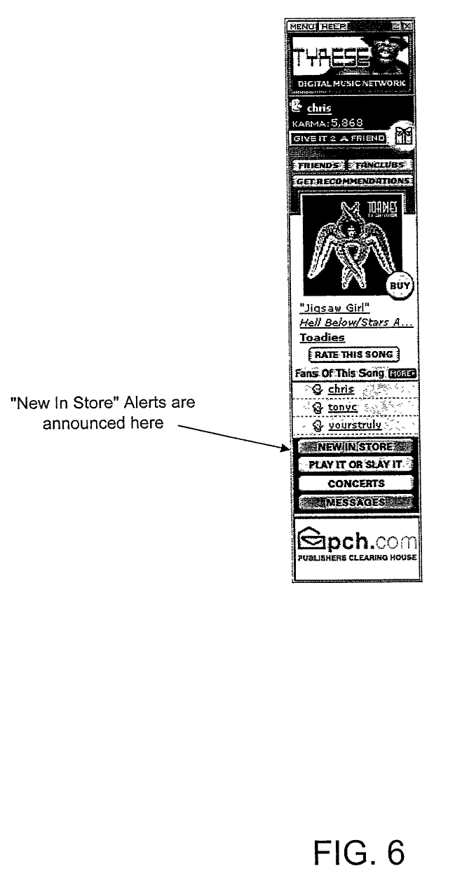

In conjunction with large music retailers, the present invention will provide a targeted, lower-cost alternative for record labels to promote their recorded music. Individual retail chains will distribute the service via their Web sites, establishing a network of their users who can be predicted to be especially receptive to receiving promotional offers from record labels to buy particular types music online. “New in Store” alerts (see FIG. 6) can be used to attract end-users to retail stores. Because the system gathers detail on members' listening preferences due to our combination of gathering preferences both passively and actively, the service is uniquely capable of identifying interesting members when a newly released music product or music-related product will appeal to them.

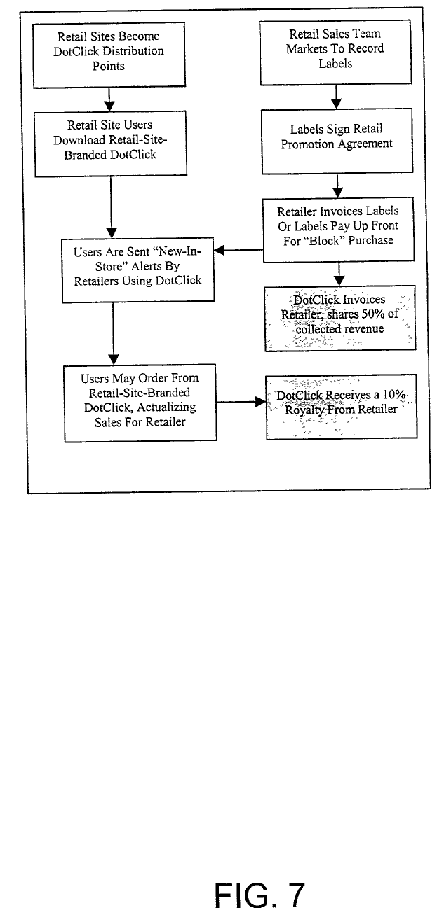

FIG. 7 illustrates a embodiment of the present invention used for a retail marketing and promotion program. The retail marketing and promotion program can be sold to record labels by an individual retailer's retail marketing and sales department (record labels may choose to run pre-release and/or post-release programs, depending on their needs). Each retailer's online division subsequently coordinates the implementation of the program, with V.I.P. customer support available. The retailer's online division creates alerts for that retailer's member base; these alerts contain information about new releases, direct links to purchase that music from that retailer's Web site, and (optionally) links to streaming audio and music video clips (see FIG. 6).

The concert touring industry is a multi-billion-dollar-per-year business. Concert promoters spend up to $75,000 per concert, advertising on local radio, print and television for shows in amphitheatres, large arenas and stadiums. A single such ad typically costs $500 to $1,000, and also often requires a free ticket giveaway. Therefore large promoters like SFX and smaller promoters such as Universal Concerts, House Of Blues Concerts, Hard Rock Chains, GoldenVoice and JAM are all accustomed to spending large amounts of money, using their promotional dollars on marketing channels that are off-line, and aren't nearly as targeted as the service.

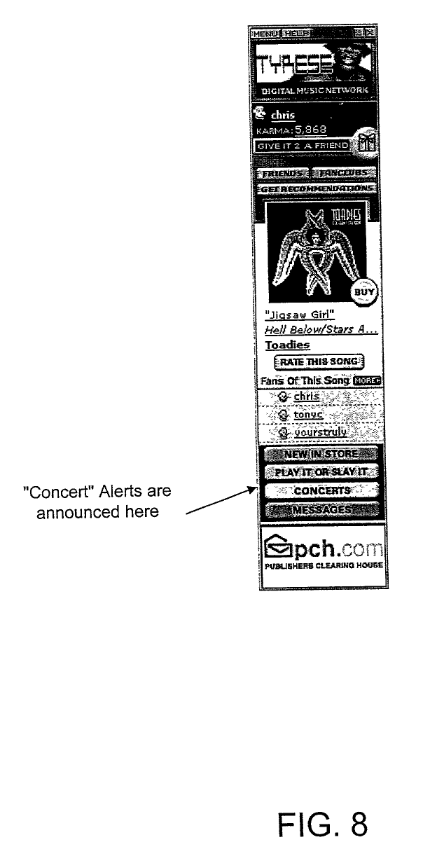

The powerful tools allow concert promoters to identify fans in 460 different Designated Marketing Areas (DMAs) across the country, and reach them with concert information and enticements to purchase tickets. On an event-by-event and market-by-market basis, the service will deliver information and one-click-shopping for concert tickets to end-users who, based upon their listening profiles, would be interested in attending a given event/concert. This is a powerful concept: as a end-user/member plays an artist's music, they are told about a concert coming to their area. It's a focused and efficient way to fill concert seats (see FIG. 8).

A tour marketing and promotion program can be sold to a promoter for a for a predefined fee (e.g., $500) per event, quite a reasonable amount considering how much promoters currently pay for a single radio, print or TV spot. That promoter creates alerts, along with links to Web sites where tickets to the event may be purchased, and then targets these alerts using the present invention's behind-the-scenes geography and preferred-genre targeting mechanism. Members receive these alerts instantly when they've indicated that they're interested in the artist(s) in question, or, even more powerfully, the moment they play music by that artist(s).

While an initial member base is being established, some key Charter Affiliated Partners will not have to “pay for play” on the Digital Music Network. In other words, Charter Partners distribute a co-branded service, the ability to send targeted alerts and e-mails, and the ability to view demographic reports about select members on the Digital Music Network. After a predetermined amount of time (e.g., first year), however, this will change. Once the member base is large enough to warrant a change, new Affiliates will pay annual subscriptions to participate in the Digital Music Network. For example, for $5,000 per year per artist, an artist, label, management company and any other potential Affiliate receives unlimited access to basic Affiliate services: co-branded download, alerts, e-mails and reports. Emerging-Artist Affiliate Subscriptions can also be provided at a predetermined cost (e.g., $1,000) per year. Emerging-Artist Subscriptions offer the same services as established-artist services but are limited to artists who do not have any gold-selling or platinum-selling records.

Alternate implementation models of the present invention exist. While advertising can not be relied upon as a major source of income, an application as “sticky” as the Digital Music Network will generate a significant number of ad-bearing page views.

The present invention allows for pursuing a strategy whereby investments can be actualized that Web portals (such as Lycos) have made in media players (such as the Sonique player), by integrating with downloads of such players, and leveraging their user bases to create larger, more attractive promotional channels.

Estimates are that when approximately a five million member users base is reached, consumer product marketing programs—wherein consumer products use the alerts system to target potential purchasers and thus reduce their cost of sales—will be a viable program.

As the user base grows, implementers of the service can augment its “flat-rate” Affiliate Subscription model to include some “a la carte” items for sale to Affiliates, including the ability to email and send Alerts outside the Affiliate's member base, the ability to receive more detailed listening reports, and more.

While this invention has been particularly shown and described with references to preferred embodiments thereof, it will be understood by those skilled in the art that various changes in form and details may be made therein without departing from the scope of the invention encompassed by the appended claims. For example a “piece of music”, audio recording or media recording is meant to encompass any recorded media, including audio, video and multimedia (e.g., an media recording on CD, a video recording on DVD, etc . . . ).

What is claimed is:

1. A method for providing targeted market testing and promotion of a media recording for an media recording distribution entity, comprising:
using a computer program plug-in, collecting information related to a playing media recording;
based upon the collected information, storing and cross-referencing the playing media recording preferences in a user preference database;
identifying computer users having a preference associated with the media recording by analyzing the user preference database;
distributing a selected media recording to the identified users for playing;
gathering user reactions to the selected media recording both actively and passively; and
analyzing and reporting on the gathered user reaction information

2. The method of claim 1 wherein the analyzing and reporting allow users to recruit other users to be targeted for distributions.

3. The method of claim 1 wherein the media recording distribution entity is a radio station.

4. A method for providing retail marketing and promotion of an media recording for an media recording distribution entity, comprising:
using a computer program plug-in, collecting information related to a playing media recording;
based upon the collected information, storing and cross-referencing the playing media recording preferences in a user preference database;
identifying computer users having a preference associated with the media recording by analyzing a user preference database;
distributing to the identified users a message regarding information for purchasing the media recording;
gathering user reactions to the message both actively and passively; and
analyzing and reporting on the gathered user reaction information.

5. The method of claim 4 wherein the analyzing and recording allow users to recruit other users to be targeted for distributions.

6. The method of claim 4 wherein the media recording distribution entity is a media recording retailer.

7. A method for providing marketing and promotion for a concert, comprising:
identifying computer users having a preference associated with the concert by analyzing a user preference database;
selecting identified users according to a relationship between the geographic location of the concert and a designated marketing area associated with the user;
distributing to the selected users a message regarding the concert.

8. The method of claim 7 wherein the distributing farther includes using the message to enable the user to purchase tickets for the concert.

9. The method of claim 7 wherein the message is distributed in real-time as the user is listening to a media recording associated with the concert.

10. The method of claim 7 wherein the selected users recruit other users to be targeted for distributions.
